(19) United States
(12) Patent Application Publication
(10) Pub. No.: US 2012/0114156 A1
(43) Pub. Date: May 10, 2012

(54) HEARING AID AND METHOD FOR OPERATING A HEARING AID WITH A HUMIDITY SENSOR

(75) Inventors: MAJA SERMAN, ERLANGEN-BUCKENHOF (DE); MEIKE STEINBUSS, ERLANGEN (DE)

(73) Assignee: SIEMENS MEDICAL INSTRUMENTS PTE. LTD., SINGAPORE (SG)

(21) Appl. No.: 13/289,620

(22) Filed: Nov. 4, 2011

(30) Foreign Application Priority Data
Nov. 5, 2010 (DE) 10 2010 043 496.5

(51) Int. Cl. H04R 25/00

(52) U.S. Cl. 381/314

(57) ABSTRACT

A hearing aid has a hearing aid housing and an associated method for operating the hearing aid. The hearing aid contains a first humidity sensor which determines a first ambient humidity and a modification unit, which modifies an operating state and/or an operating parameter of the hearing aid in dependence on the first ambient humidity detected. The hearing aid takes account of the effect of the humidity of the environment on the hearing aid properties and takes measures to compensate for the humidity.

### CROSS-REFERENCE TO RELATED APPLICATION

This application claims the priority, under 35 U.S.C. §119, of German application DE 10 2010 043 496.5, filed Nov. 5, 2010; the prior application is herewith incorporated by reference in its entirety.

### BACKGROUND OF THE INVENTION

### FIELD OF THE INVENTION

The invention relates to hearing aid with a hearing aid housing and with at least one humidity sensor and to a method for operating a hearing aid with determination of at least one ambient humidity.

Hearing aids are wearable hearing devices serving to aid persons with impaired hearing. In order to meet the numerous individual requirements, different forms of hearing aid such as behind-the-ear hearing aids, hearing aids with external earpieces and in-the-ear hearing aids, e.g. also Concha hearing aids or in-canal hearing aids, are provided. The hearing aids given by way of example are worn on the outer ear or in the auditory canal. In addition there are also bone-conduction hearing aids, implantable or vibrotactile hearing aids available on the market. In such cases the damaged hearing is stimulated either mechanically or electrically.

In principle hearing aids possess an input transducer, an amplifier and an output transducer as their major components. The input transducer is generally a sound receiver, e.g. a microphone and/or an electromagnetic receiver, e.g. an induction coil. The output transducer is mainly implemented as an electro-acoustic converter, e.g. miniature loudspeaker or as electro-mechanical converter, e.g. bone conduction earpiece. The amplifier is usually integrated into a signal processing unit. This basic structure is shown in FIG. 1, using a behind-the-ear hearing aid 1 as an example. Two microphones 3 for receiving the sound from the environment are usually built into a hearing aid housing 2 for wearing behind the ear. Microphone openings 7 are embodied in the hearing aid housing 2 above the microphones 3. The sound can reach the microphones 3 within the hearing aid housing through the sound openings 7. A signal processing unit 4, which is likewise integrated into the hearing aid housing 2, processes the microphone signals and amplifies them. The output signal of the signal processing unit 4 is transmitted to a loudspeaker or earpiece 5, which outputs an acoustic signal. The sound is transmitted to the eardrum of the hearing aid wearer if necessary via a sound tube not shown in the FIG. 1, which is fixed to an otoplastic in the auditory canal. Energy is supplied to the hearing aid 1 and especially to the signal processing unit 4 by a battery 6 likewise integrated into the hearing aid housing 2.

With hearing aids the problem often occurs of moisture collecting within the hearing aid housing. This can penetrate into the device from outside or condensation water forms within the device. The moisture in the device can adversely affect the function of the sensitive electrical and mechanical components of the hearing aid. German patent DE 10 2007 044 205 B3, corresponding to U.S. patent publication No. 2009/0074219, thus discloses the method of removing the moisture in the housing by use of an electrical heating device.

Moisture sensors are known for the detection of moisture. For example published European patent application EP 2136975 A1 specifies a Cochlea implant which includes a moisture sensor for generating a signal. The signal indicates moisture within the implant.

International patent disclosure WO 2010/120243 A1 specifies a hearing aid with a measurement sensor arranged on a hearing aid housing for detection of environmental parameters such as moisture for example, on the basis of which measured values at least one hearing a parameter can be modified.

German patent DE 101 41 800 C1, corresponding to U.S. Pat. No. 6,819,770, discloses an in-the-ear hearing aid with a sensor for detecting the air humidity in an enclosed auditory canal volume.

### SUMMARY OF THE INVENTION

It is accordingly an object of the invention to provide a hearing aid and a method for operating a hearing aid with a humidity sensor which overcome the above-mentioned disadvantages of the prior art methods and devices of this general type, which take account of the influence of humidity on the hearing aid.

The invention claims a hearing aid with a hearing aid housing, a first humidity sensor which measures a first ambient humidity and a modification unit which modifies an operating state and/or an operating parameter of the hearing aid in dependence on the first ambient humidity determined. In addition the hearing aid includes a second humidity sensor arranged within the hearing aid housing which determines a second level of ambient humidity inside the hearing aid housing. The invention offers the advantage of being able to take account of the effect of humidity within and outside the hearing aid on the hearing aid properties and of allowing compensation measures to be taken.

In a development the modification unit can modify at least one hearing aid parameter as a function of the first ambient humidity determined. This has the advantage of enabling the hearing aid properties to be adapted to the ambient humidity.

In a further form of embodiment the modification unit can switch to another hearing aid program in dependence on the first ambient humidity determined. This offers the advantage of enabling the program preset in accordance with the humidity currently obtaining to be used.

Furthermore the modification unit can switch the hearing aid on or off in dependence on the first ambient humidity determined. A feedback level that is too high can typically be avoided in this way. In a development of the invention the first humidity sensor can be arranged outside on the hearing aid housing or integrated into the hearing aid housing and can determine the first ambient humidity outside the hearing aid.

Furthermore the hearing aid can include a signal generation unit which generates a warning signal when the second ambient humidity exceeds a predeterminable threshold.

In a further embodiment the hearing aid can include an earpiece which acoustically outputs the generated warning signal.

Furthermore the hearing aid can transmit the warning signal electromagnetically to a remote control.

In a development the hearing aid can have a salt content measurement sensor which determines the salt content outside the hearing aid housing. This enables critical corrosion states to be detected.

Preferably the salt content measurement sensor can be arranged outside on the hearing aid housing or can be integrated into the hearing aid housing.

The invention also recites a method for operating a hearing aid, with the following steps: determining a first ambient humidity, modifying an operating state and/or an operating parameter of the hearing aid in dependence on the first ambient humidity determined and determining a second ambient humidity within the hearing aid.

In a further form of embodiment the modification modifies a hearing aid parameter, switches into another hearing aid program and/or switching off or switching on the hearing aid in dependence on the first ambient humidity determined.

In a development the first ambient humidity can be determined outside the hearing aid housing.

The method can also include issuing a warning signal if the second ambient humidity exceeds a predeterminable threshold value.

Preferably the warning signal can be issued acoustically by an earpiece of the hearing aid and/or transmitted electromagnetically to a remote control.

In a development a salt content can be determined on or in the hearing aid housing. Damaging salt from perspiration can be detected in this way.

Furthermore a salt warning signal can be output if the salt content determined exceeds a predeterminable salt content threshold.

Other features which are considered as characteristic for the invention are set forth in the appended claims.

Although the invention is illustrated and described herein as embodied in a hearing aid and a method for operating a hearing aid with a humidity sensor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a behind-the-ear hearing aid according to the prior art;

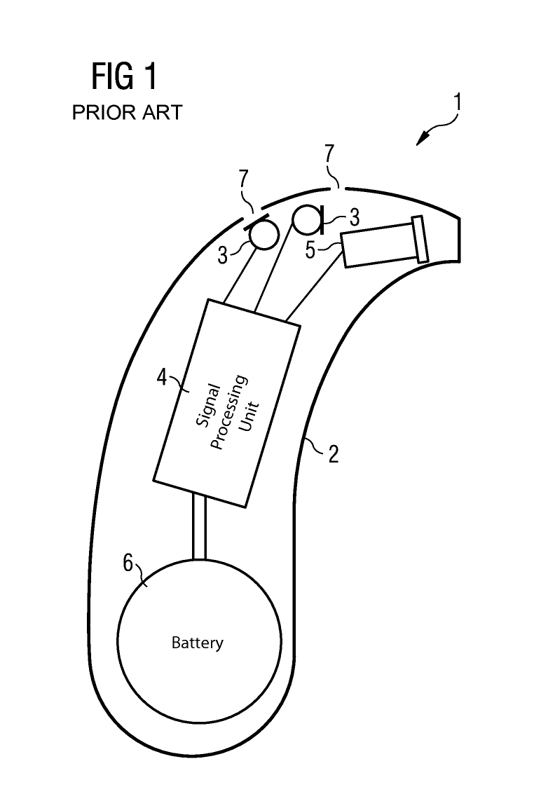

FIG. 2 is an illustration of a hearing aid housing with a first exterior humidity sensor according to the invention;

FIG. 3 is an illustration of the hearing aid housing with a first and a second humidity sensor; and

FIG. 4 is a flowchart of a method for operating a hearing aid with humidity measurement.

### DETAILED DESCRIPTION OF THE INVENTION

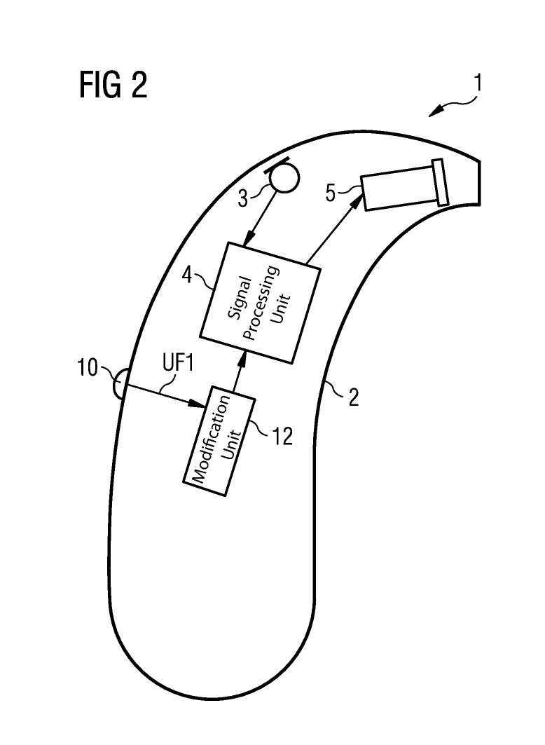

Referring now to the figures of the drawing in detail and first, particularly, to FIG. 2 thereof, there is shown a behind-the-ear hearing aid 1 with a hearing aid housing 2. Arranged in the hearing aid housing 2 are a microphone 3, an earpiece 5, a signal processing unit 4 and a modification unit 12. In accordance with the invention a first humidity sensor 10 which detects a first ambient humidity UF1 sits on the hearing aid housing 2.

Since the first humidity sensor 10 is arranged outside the hearing aid housing 2, the first ambient humidity UF1 corresponds to the humidity outside the hearing aid 1. A high first humidity UF1 influences the acoustic properties of the hearing aid 1 so that counter measures have to be taken. For this purpose the first humidity sensor 10 is connected to the modification unit 12 which modifies the operating state or an operating parameter of the hearing aid 1 in accordance with the first ambient humidity UF1 determined. For this purpose the modification unit 12 is connected to the signal processing unit 4.

For example, depending on the first ambient humidity UF1, a hearing aid parameter, such as the amplification, can be modified. Or the hearing aid 1 is switched to another hearing aid program. With high humidity, which spells danger for the hearing aid 1, the hearing aid 1 can also be automatically switched off. On the other hand, if the ambient humidity UF1 drops, the hearing aid 1 can be automatically switched back on again.

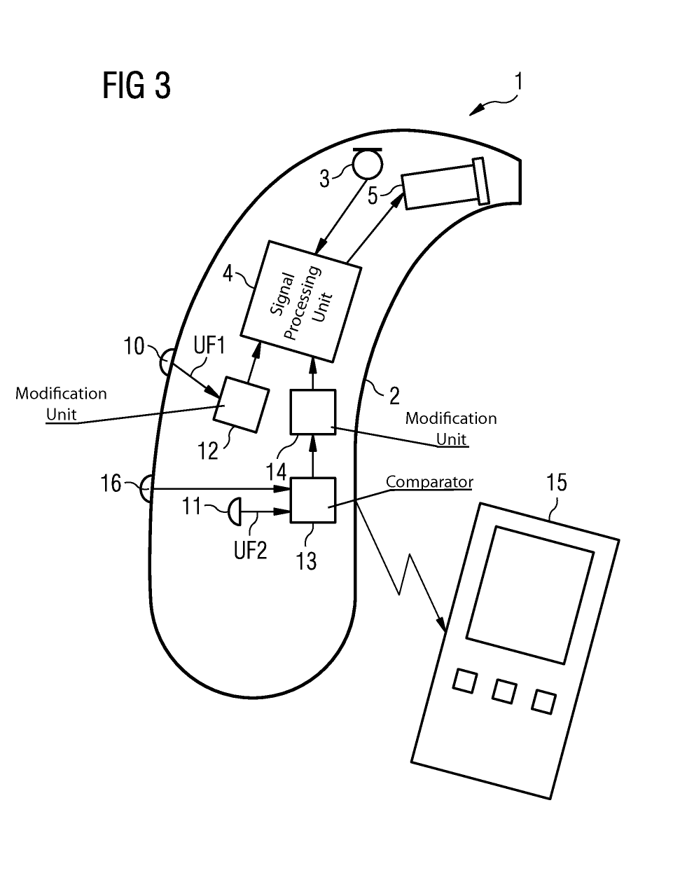

FIG. 3 shows a behind-the-ear hearing aid 1 with a hearing aid housing 2. Arranged in the hearing aid housing 2 are the microphone 3, the earpiece 5, the signal processing unit 4 and the modification unit 12. In accordance with the invention the first humidity sensor 10 which determines the first ambient humidity UF1 sits on the hearing aid housing 2. Furthermore a second humidity sensor 11, a comparator unit 13 and a signal output unit 14 are arranged inside the hearing aid housing 2.

Since the first humidity sensor 10 is arranged outside the hearing aid housing 2, the first ambient humidity UF1 corresponds to the humility outside the hearing aid 1. A high first ambient humidity UF1 influences the acoustic properties of the hearing aid 1, so that measures have to be taken to counter this. For this purpose the first humidity sensor 10 is connected to the modification unit 12, which in accordance with the measured first ambient humidity UF1, modifies the operating state and/or an operating parameter of the hearing aid 1. To this end the modification unit 12 is connected to the signal processing unit 4.

For example a hearing aid parameter, such as the amplification, can be modified in dependence on the first ambient humidity UF1. Or the hearing aid 1 is switched to another hearing aid program. With high humidity, which represents a danger for the hearing aid 1, the hearing aid 1 can also be automatically switched off. On the other hand, if the first ambient humidity UF1 drops, the hearing aid 1 can be automatically switched back on again.

The second humidity sensor 11 inside the hearing aid 1 measures the second ambient humidity UF2, which corresponds to the humidity obtaining inside the hearing aid housing 2. A high humidity inside the hearing aid 1 can lead to damage to the hearing aid 1. Thus the second humidity sensor 11 is connected to the comparator unit 13 which compares a measured second ambient humidity UF2 with a threshold value. If the threshold value is exceeded the signal generation unit 14 will be made to output an electrical and/or an electromagnetic warning signal. The electrical warning signal is processed in the signal processing unit 4 and is transferred to the earpiece 5 where it is converted into an acoustic warning signal and as such can be heard by a hearing aid wearer. In addition or as an alternative the warning signal is transmitted wirelessly to a remote control 15, where it can be shown on a display for example. The threshold value is selected so that the warning signal detects humidity that endangers the operation of the hearing aid 1 and for example advises a visit to a hearing aid acoustician or requests that the hearing aid be dried or does this automatically.

Too much salt in the environment of the hearing aid 1 can also be damaging for the hearing aid 1. The salt can typically be deposited by perspiration of the hearing aid wearer. Therefore a salt content measurement sensor 16 measures the salt concentration outside the hearing aid housing 2 and passes on this information to the comparator unit 13. If the threshold value is exceeded, on exceeding the threshold value for the second ambient humidity UF2 a corresponding warning signal is generated by the signal generation unit 14.

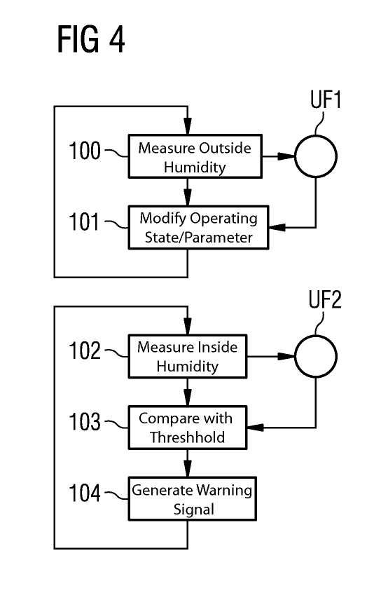

FIG. 4 shows a flow diagram of a method for inventive operation of a hearing aid. In step 100 a first ambient humidity UF1 is determined, which corresponds to the humidity outside the hearing aid. The measured first ambient humidity UF1 is used in step 101 to modify an operating state or to modify an operating parameter. For example, for a high first ambient humidity UF1 the amplification of the hearing aid can be reduced.

In parallel to steps 100 and 101, in step 102 a second ambient humidity UF2 is determined, which corresponds to the humidity within the hearing aid. In step 103 the second ambient humidity UF2 is compared to a threshold value and the warning signal is generated if the threshold is exceeded. In step 104 the warning signal is output via an earpiece of the hearing aid and/or is transmitted wirelessly to a remote control where a corresponding warning can be displayed. The acoustic warning signal of the earpiece can include both a signal tone and also a voice message.

1. A hearing aid, comprising:
a hearing aid housing;
a first humidity sensor for determining a first ambient humidity;
a modification unit for modifying at least one of an operating state or an operating parameter of the hearing aid in dependence on the first ambient humidity determined, said modification unit coupled to said first humidity sensor; and
a second humidity sensor disposed inside said hearing aid housing for determining a second ambient humidity inside said hearing aid housing.

2. The hearing aid according to claim 1, wherein said modification unit modifies at least one hearing aid parameter in dependence on the first ambient humidity detected.

3. The hearing aid according to claim 1, wherein said modification unit switches to another hearing aid program in dependence on the first ambient humidity detected.

4. The hearing aid according to claim 1, wherein said modification unit switches the hearing aid on or off in dependence on the first ambient humidity detected.

5. The hearing aid according to claim 1, wherein said first humidity sensor is disposed on an exterior of said hearing aid housing or is integrated into said hearing aid housing and determines the first ambient humidity outside the hearing aid.

6. The hearing aid according to claim 1, further comprising a signal generation unit for generating a warning signal if the second ambient humidity exceeds a predeterminable threshold value.

7. The hearing aid according to claim 6, further comprising an earpiece for acoustically outputting the warning signal.

8. The hearing aid according to claim 6, wherein the hearing aid transmits the warning signal electromagnetically to a remote control.

9. The hearing aid according to claim 1, further comprising a salt content measurement sensor for determining a salt content outside said hearing aid housing.

10. The hearing aid according to claim 9, wherein said salt content measurement sensor is disposed outside on said hearing aid housing or is integrated into said hearing aid housing.

11. A method for operating a hearing aid, which comprises the steps of:
determining a first ambient humidity;
modifying at least one of an operating state or an operating parameter of the hearing aid in dependence on the first ambient humidity determined; and
determining a second ambient humidity within the hearing aid.

12. The method according to claim 11, wherein the modifying step includes the further steps of:
modifying at least one hearing aid parameter; and
performing at least one of:
switching to another hearing aid program; or
switching the hearing aid on or off in dependence on the first ambient humidity detected.

13. The method according to claim 11, which further comprises determining the first ambient humidity outside of the hearing aid housing of the hearing aid.

14. The method according to claim 11, which further comprises issuing a warning signal if the second ambient humidity exceeds a predeterminable threshold value.

15. The method according to claim 14, which further comprises outputting the warning signal one of acoustically by an earpiece of the hearing aid or transmitting the warning signal electromagnetically to a remote control.

16. The method according to claim 11, which further comprises determining a salt content at least one of on or in the hearing aid housing.

17. The method according to claim 16, which further comprises outputting a salt warning signal if the salt content determined exceeds a predeterminable salt content threshold value.
